(19) United States
(12) Patent Application Publication
(10) Pub. No.: US 2026/0290970 A1
(43) Pub. Date: Sep. 24, 2026

(54) EXPANSION FORMING PROCESS FOR MANUFACTURING A STAMPED BATTERY HOUSING

(71) Applicants: Brent MEIER, Etobicoke (CA); Alexander OETJENS, Brooklyn, NY (US); Theodore GRABOW, Hazel Park, MI (US); Darren WOMACK, LaSalle (CA); MAGNA INTERNATIONAL INC., Aurora (CA)

(72) Inventors: Brent MEIER, Etobicoke (CA); Alexander OETJENS, Brooklyn, NY (US); Theodore GRABOW, Hazel Park, MI (US); Darren WOMACK, LaSalle (CA)

(21) Appl. No.: 19/477,650

(22) PCT Filed: Apr. 26, 2024
(86) PCT No.: PCT/US2024/026485

§ 371 Date: Oct. 22, 2025

Related U.S. Application Data
(60) Provisional application No. 63/462,059, filed on Apr. 26, 2023.
(60) Provisional application No. 63/571,563, filed on Mar. 29, 2024.

(51) Int. Cl. H01M 50/242; B60L 50/64; H01M 50/249; H01M 50/271

(52) U.S. Cl. CPC H01M 50/242; H01M 50/249; H01M 50/271; B60L 50/64; H01M 2220/20

(57) ABSTRACT

A battery housing for an automobile includes a lower tub, and an upper cover disposed on the lower tub to collectively define an internal cavity. At least one battery module is disposed in the internal cavity and enclosed between the lower tub and the upper cover. At least one of the lower tub or the upper cover is formed as a one-piece stamped component from a two-part expansion forming process. In a preferred arrangement, both of the lower tub and the upper cover of the battery housing are each formed as one-piece stamped components from the two-part expansion forming process, providing both an upper cover and a lower tub having tighter draft angles (less than two degrees) and sharper upper and lower corners (plan view corner radii of between 20-95 mm, etc.) relative to the prior art one-piece stamped component designs, resulting in increased space for the internal cavity.

### CROSS-REFERENCE TO RELATED APPLICATIONS

This PCT International Patent application claims the benefit of and priority to U.S. Provisional Patent Application Ser. No. 63/462,059, filed Apr. 26, 2023, titled “Expansion Forming Process For Manufacturing A Stamped Battery Housing” and U.S. Provisional Patent Application Ser. No. 63/571,563, filed Mar. 29, 2024, titled “Expansion Forming Process For Manufacturing A Stamped Battery Housing,” the entire disclosures of which are hereby incorporated by reference in its entirety.

### BACKGROUND OF THE INVENTION

### 1. Field of the Invention

The present invention relates to a battery housing for an automobile, and more particularly to a method of manufacturing same.

### 2. Related Art

This section provides background information related to the present disclosure which is not necessarily prior art.

Automobiles are the subject of a continuing effort to move away from internal combustion engines towards electrified vehicles, to reduce their dependency on fuel, improve emissions and increase fuel efficiency. Thus, this desire to increase fuel efficiency is both economically and environmentally motivated and has led to advanced internal components in automobiles as evidenced by developments in batteries, particularly in electrified automobiles. Unlike traditional automobiles that operate entirely with fossil fuels, electrified automobiles include a range of technologies that rely on electric energy. Even though electric energy is a more economical and environmentally friendly option over relying completely on fossil fuels, batteries are heavy, expensive, and relatively fragile compared to neighboring mechanical components. As such, the packaging of batteries, particularly within electrified automobiles, requires a number of design considerations including weight distribution, temperature regulation, and serviceability. In terms of serviceability, there is a growing need, particularly with electrified automobiles, for the batteries to be stowed in such a manner to be charged and maintained without removal.

To meet the above minimum requirements, batteries have traditionally been packaged in protective battery housings. In some cases, these traditional battery housings have been formed from multi-piece aluminum (e.g., a welded structure comprised of multiple aluminum extruded parts or discrete stampings joined together) or SMC plastic materials. In other cases, a lower tub and/or an upper cover component of the battery housing can be formed as a one-piece stamped component to provide a sealed design (i.e., one devoid of welded seams that are prone for leakage) for the resultant battery housing. However, the deep drawing down process utilized for forming the prior art one-piece stamped components creates spring back and has forming issues, like splitting of the metal blank. Thus, it is difficult to control the forming performance and resultant material in the prior art methods of forming one-piece stamped components for the upper cover and/or lower tub. The prior art one-piece stamped components are also not optimized for creating maximum space within an internal cavity of the resultant battery housing. Accordingly, there remains a continuing need for improved processes for manufacturing one-piece components (e.g., upper cover and/or lower tub) of the battery housing.

### SUMMARY OF THE INVENTION

The subject disclosure is directed to a battery housing including at least a lower tub or an upper cover component formed as a one-piece stamped component from a two-part expansion forming process. Put another way, the subject disclosure is directed to an expansion forming process having two separate forming steps to manufacture the one-piece stamped component (e.g., lower tub and/or upper cover) for the battery housing. The subject expansion forming process which includes expanding a metal blank using a first stamping press and a second stamping press in two consecutive forming steps provides a process with less spring back and less risks of metal splitting during the forming process. Accordingly, the one-piece stamped component for the battery housing formed from the subject two-part expansion forming process is less distorted relative to the prior art one-piece stamped components formed from the traditional deep drawing processes. The two-part expansion forming process also results in a one-piece stamped component for the lower tub and/or upper cover which has tight wall angles (less than two degrees) between a top or base surface and respective upper or lower peripheral walls, collectively creating more space within an internal cavity defined between the lower tub and the upper cover of the resultant battery housing.

### BRIEF DESCRIPTION OF THE DRAWINGS

These and other advantages of the present disclosure will be more readily understood by reference to the following description in combination with the accompanying drawings wherein:

FIG. 1 is a perspective view of a one-piece stamped upper cover and a one-piece stamped lower tub each formed in accordance with the subject two-part expansion forming process;

FIG. 2 is an exploded perspective view of an exemplary battery housing illustrating a plurality of battery modules and a plurality of cross members disposed within an internal cavity defined by the upper cover and the lower tub;

FIG. 3 is a side fragmentary cross-sectional view illustrating a first part OP-10 formed from a first forming operation step in the two-part expansion forming process overlaid with a second, final part OP-20 formed from a second forming operation step in the two-part expansion forming process to illustrate an expansion of the first part OP-10 in the second forming operation step and a reduction of the first larger angle ⊖_{R1} extending between an upper surface and a side surface of the first part OP-10 to a second smaller angle ⊖_{R2} between these same surfaces in the final part OP-20;

FIG. 4A is a side fragmentary cross-sectional view illustrating the first forming operation step in the two-part expansion forming process in which a metal blank is placed within a first stamping press to form the first part OP-10;

FIG. 4B is a top fragmentary view illustrating a portion of the first part OP-10 formed from the fragmentary portion of the first stamping press shown in FIG. 4A;

FIG. 5A is a side fragmentary cross-sectional view illustrating the second forming operation step in the two-part expansion forming process in which the first part OP-10 is placed within a second stamping press to form the second, final part OP-20 (e.g., the one-piece stamped upper cover and/or lower tub component);

FIG. 5B is a top fragmentary view illustrating a portion of the final part OP-20 formed from the fragmentary portion of the second stamping press shown in FIG. 5A;

FIG. 6 is a one-piece stamped upper cover formed in accordance the subject two-part expansion forming process overlaid with a prior art upper cover formed in accordance with the prior art processes to comparatively illustrate a sharp upper corner formed in the subject upper cover that is sharper than corners achievable in the prior art upper cover, leading to an increased overall size of the internal cavity for the battery housing;

FIG. 7A is a magnified view of the sharp upper corner of the upper cover to more clearly illustrate an upper plan view corner radius, a first upper corner radiused portion, and a second upper corner radiused portion;

FIG. 7B is a magnified view of a sharp lower corner of the lower tub to more clearly a lower plan view corner radius, a first lower corner radiused portion, and a second lower corner radiused portion;

FIG. 8A is a cross-sectional view taken along 8A-8A of FIG. 1 to illustrate a tight draft angle of two degrees or less between each upper side wall of the upper peripheral wall and an upper plane Pu extending transversely to a top surface of the upper cover;

FIG. 8B is a cross-sectional view taken 8B-8B of FIG. 1 to illustrate the tight draft angle of two degrees or less between each upper end wall of the upper peripheral wall and the upper plane Pu extending transversely to the top surface;

FIG. 8C is a cross-sectional view taken along 8C-8C of FIG. 7A to more clearly illustrate the upper plan view corner radius of the sharp upper corner;

FIG. 8D is a cross-sectional view taken along 8D-8D of FIG. 7A to more clearly illustrate the first upper corner radiused portion and the second upper corner radiused portion of the sharp upper corner;

FIG. 9A is a cross-sectional view taken along 9A-9A of FIG. 1 to illustrate a tight draft angle of two degrees or less between each lower side wall of the lower peripheral wall and a lower plane P_{L} extending transversely to a base surface of the lower tub;

FIG. 9B is a cross-sectional view taken 9B-9B of FIG. 1 to illustrate the tight draft angle of two degrees or less between each lower end wall of the lower peripheral wall and the lower plane P_{L} extending transversely to the base surface;

FIG. 9C is a cross-sectional view taken along 9C-9C of FIG. 7B to more clearly illustrate the lower plan view corner radius for the sharp lower corner;

FIG. 9D is a cross-sectional view taken along 9D-9D of FIG. 7B to more clearly illustrate the first lower corner radiused portion and the second lower corner radiused portion of the sharp lower corner;

FIG. 10 is a top view of an upper cover formed in accordance with the prior art manufacturing methods and illustrating staker beads and drawbeads which are formed in the prior art upper covers and must be trimmed away along a product trim line, leading to significant material waste;

FIG. 11 is a section view of an exemplary prior art process illustrating the requisite staker bead and drawbead in the prior art stamping press;

FIG. 12 is a top view of an exemplary first part OP-10 formed in the first forming operation step;

FIG. 13 is a top view of an exemplary second, final part OP-20 formed in the second forming operation step;

FIG. 14 is a magnified perspective view of a portion of the second, final part OP-20 more clearly illustrating the sharp upper corner and a product trim line placed close to an outer edge of the second, final part OP-20;

FIG. 15 is a magnified and fragmentary view of the first part OP-10 illustrating a metal gainer feature defined in an upper surface and adjacent a portion of the side surface intended for ultimately forming the sharp upper or lower corner;

FIG. 16 is a magnified and fragmentary view of the final part OP-20 shown adjacent the sharp upper or lower corner to illustrate the metal gainer feature being distributed and smoothed out in the second expansion forming process; and

FIG. 17 is a magnified, perspective view of the final part OP-20 perspectively illustrating the tight wall angle between the top surface and the upper peripheral wall of the upper cover.

### DETAILED DESCRIPTION OF THE ENABLING EMBODIMENTS

Example embodiments will now be described more fully with reference to the accompanying drawings. In general, the subject embodiments are directed to a battery housing for an automobile and a method of manufacturing same. However, the example embodiments are only provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

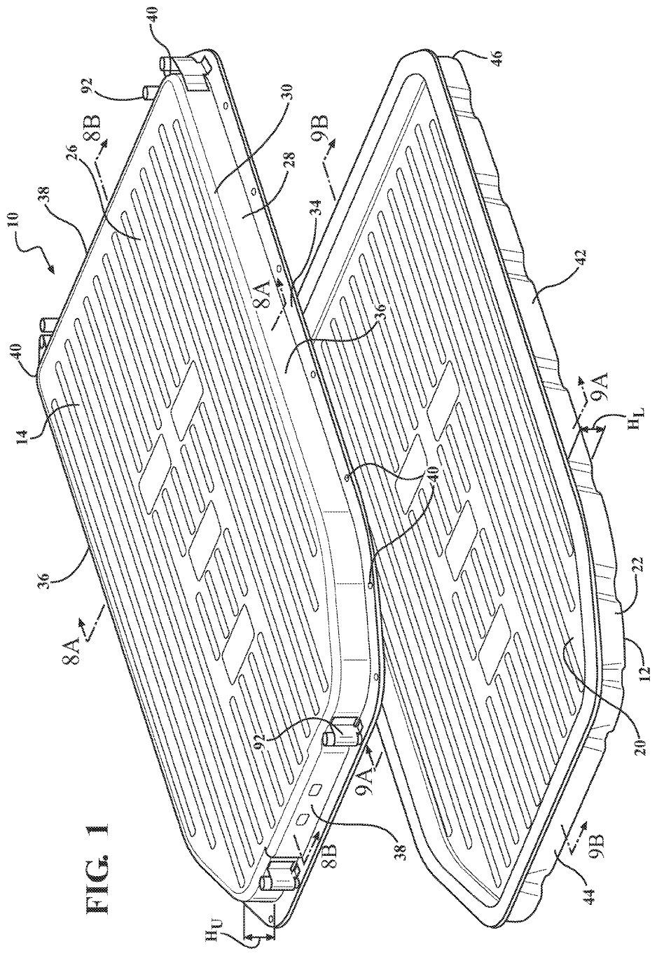

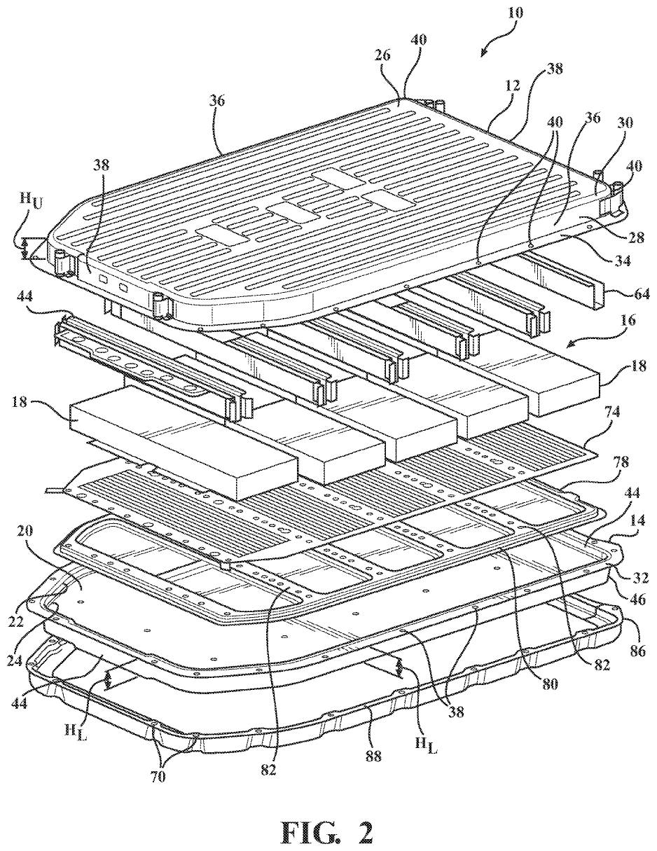

As illustrated in FIGS. 1-2, the battery housing 10 includes a lower tub 12, and an upper cover 14 is disposed on the lower tub 12 to collectively define an internal cavity 16. At least one battery module 18, and preferably a plurality of battery modules 18 are disposed in the internal cavity 16 and enclosed between the lower tub 12 and the upper cover 14 to seal and isolate the plurality of battery modules 16 from an environment of the battery housing 10. At least one of the lower tub 12 or the upper cover 14 is formed from steel, preferably having greater than 110 MPa yield strength, to provide a one-piece integral component. In a preferred embodiment, both the lower tub 12 and the upper cover 14 of the battery housing are each formed as integral one-piece stamped steel components. Use of a one-piece stamped lower tub 12 and upper cover 14 eliminates the presence of any leak paths in these components (because a weld is not present and required to form the individual components), and thus provides an improved seal design over the prior art designs which require multiple pieces to form the lower tub 12 and/or the upper cover 14.

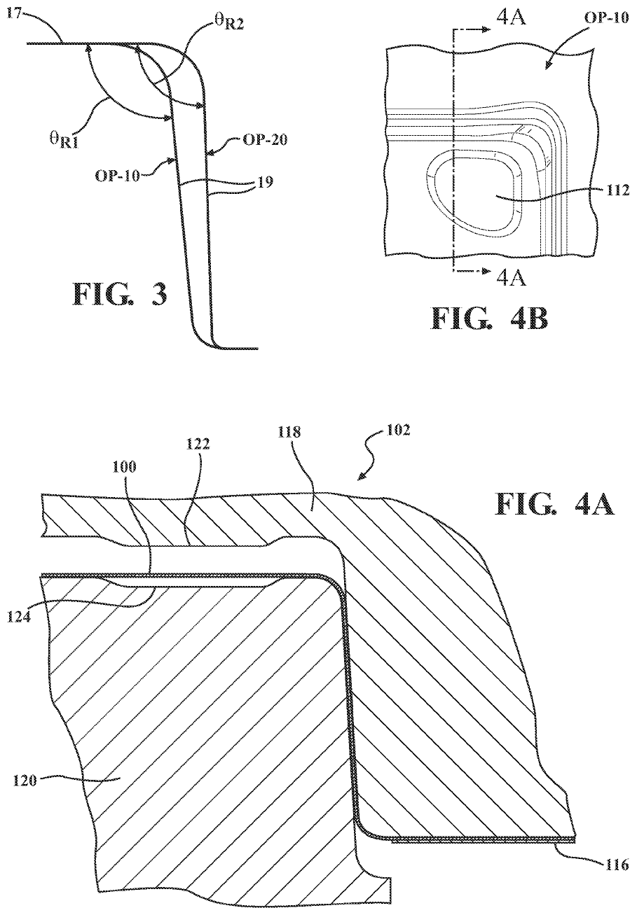

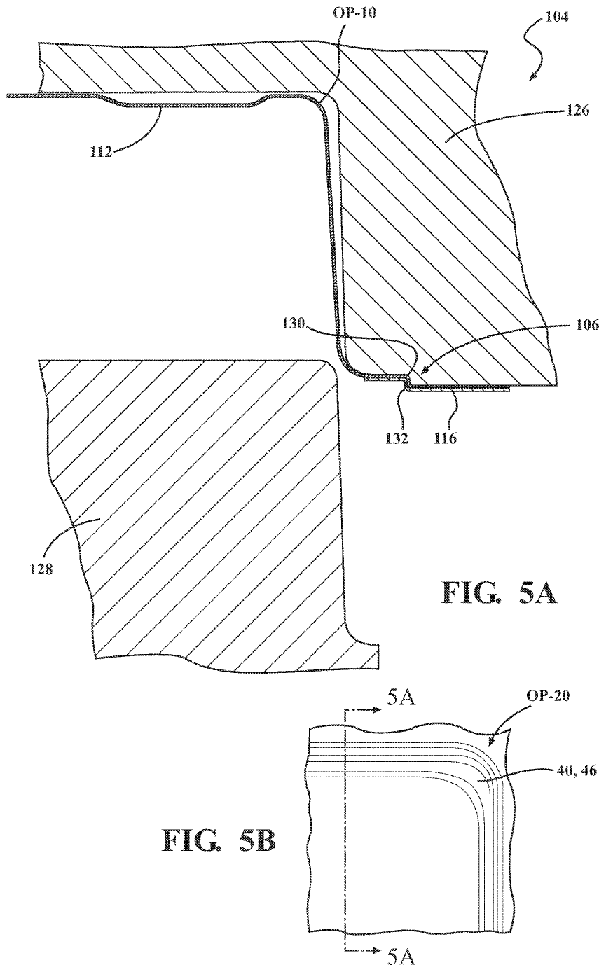

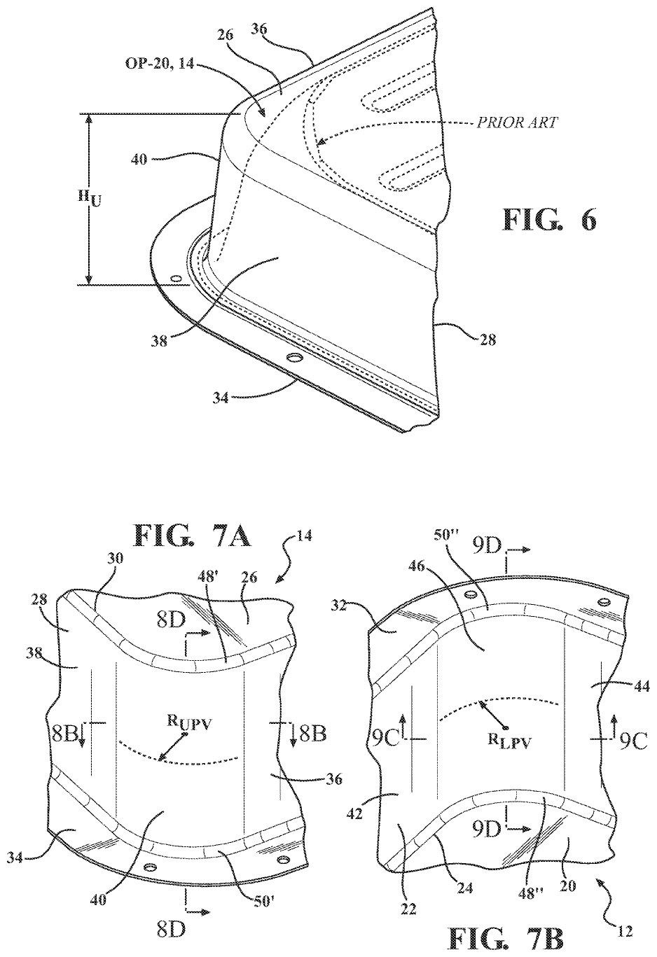

As best illustrated in FIGS. 3, 4A, and 5A, the subject design and related manufacturing method utilizes an expansion forming process having two separate forming steps to manufacture the one-piece stamped component (e.g., the lower tub 12 and/or the upper cover 14 for the battery housing 10). More specifically, as illustrated in FIG. 4A, a first forming operation step of the expansion forming process includes placing a metal blank 100 within a first stamping press 102 to initially form a first part OP-10. As illustrated in FIG. 5A, a second forming operation step of the expansion forming process includes placing the first part OP-10 within a second stamping press 104 to form a second, final part OP-20. As best illustrated in FIG. 3, the second forming operation step expands the first part OP-10 to its final form in OP-20, in this case to create the one-piece stamped upper cover 14 and/or lower tub 12. In other words, the tool in the second stamping press 104 expands the metal in the first part OP-10 outwardly to form the final part OP-20, which in this instance is the one-piece stamped upper cover 14 or lower tub 12. However, the two-part expansion forming process can also be applied to forming other parts, including other vehicle parts, in which tighter draft angles and sharper corners are required or desired in the one-piece stamped components, without departing from the scope of the subject disclosure.

As best illustrated in FIG. 3, the first part OP-10 has a first larger angle ⊖_{R1} extending between an upper surface 17 and a side surface 19 which is then reduced to a second smaller angle ⊖_{R2} between these same surfaces 17, 19 as the first part OP-10 is expanded to its final form as OP-20 in the second forming operation step. This two-part expansion forming process achieves tighter draft angles and sharper corners in the resultant OP-20 one-piece stamped component than achievable in the prior art one-piece stamped components. Thus, in this instance when being applied to the upper cover 14 and lower tub 12 components of the battery housing 10, the tighter draft angles and sharper corners provide for more space in the internal cavity 16 to house the plurality of battery modules 18, or other components in the battery housing 10, as will be explained in more detail below.

More specifically in relation to the exemplary arrangement of the battery housing 10, and as best illustrated in FIGS. 1-2, the lower tub 12 includes a base surface 20 and a lower peripheral wall 22 extending upwardly from a peripheral lower edge 24 of the base surface 20. Similarly, the upper cover 14 includes a top surface 26 and an upper peripheral wall 28 extending downwardly from a peripheral upper edge 30 of the top surface 26. The lower tub 12 includes a lower flange 32 extending outwardly from the lower sidewall 22, and the upper cover 14 includes an upper flange 34 extending outwardly from the upper sidewall 28 and which is disposed in overlaying relationship with the lower flange 32 when the upper cover 14 is disposed on the lower tub 12.

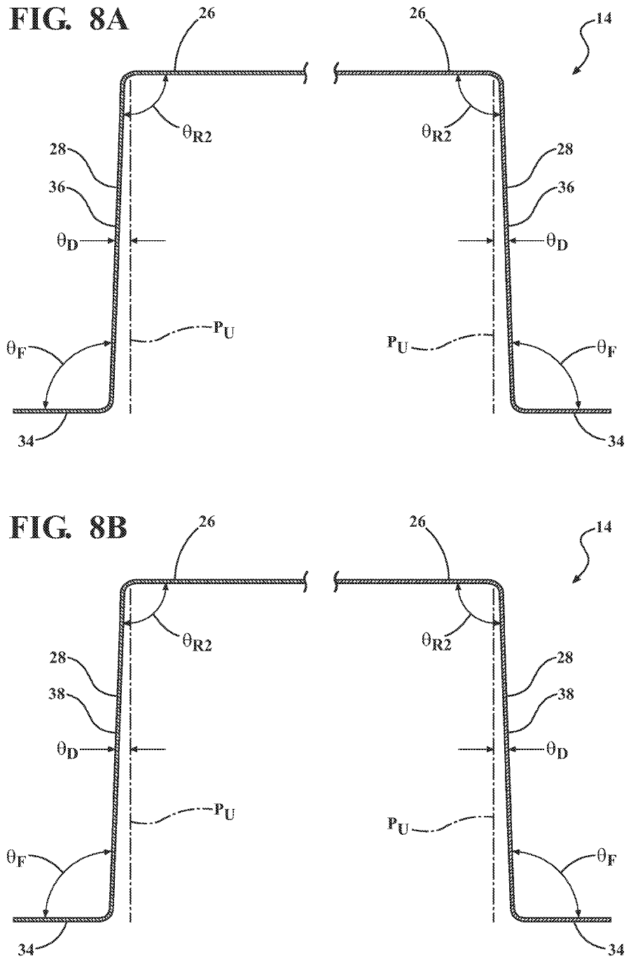

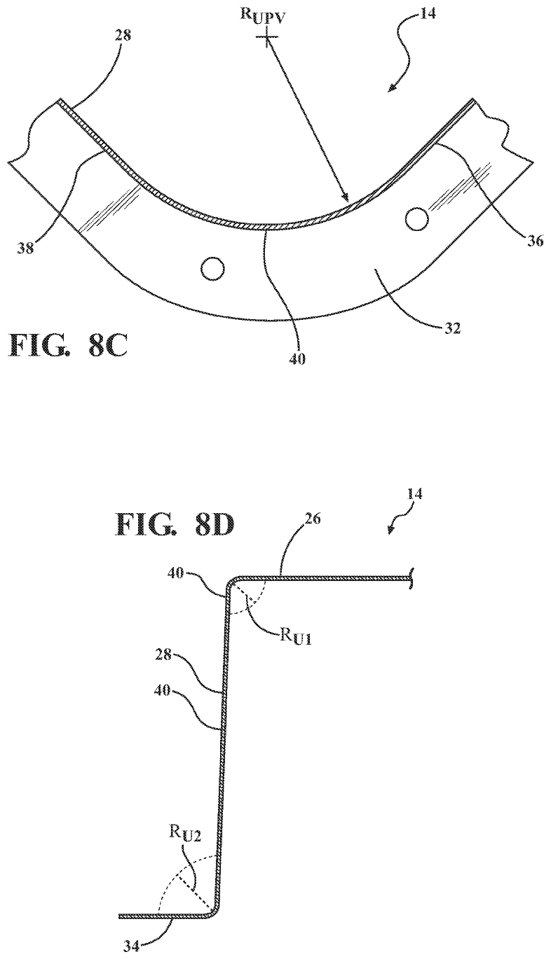

As shown in FIGS. 8A-8B, the resultant upper cover 14 formed as a one-piece stamped component from the two-part expansion forming process advantageously has a tight draft angle ⊖_{D} of less than two degrees, and more preferably of less than 1.5 degrees, as defined between the upper peripheral wall 28 and an upper plane Pu extending transversely to the top surface 26. Thus, the angle ⊖_{R2} shown in FIGS. 8A-8B for the resultant upper cover 14 (which is the same as ⊖_{R2} for the generally shown OP-20 part illustrated in FIG. 3) is between 90 and 92 degrees, as defined between the top surface 26 (which would be the upper surface 17 in FIG. 3) and the upper peripheral wall 28 (which would be the side surface 19 in FIG. 3).

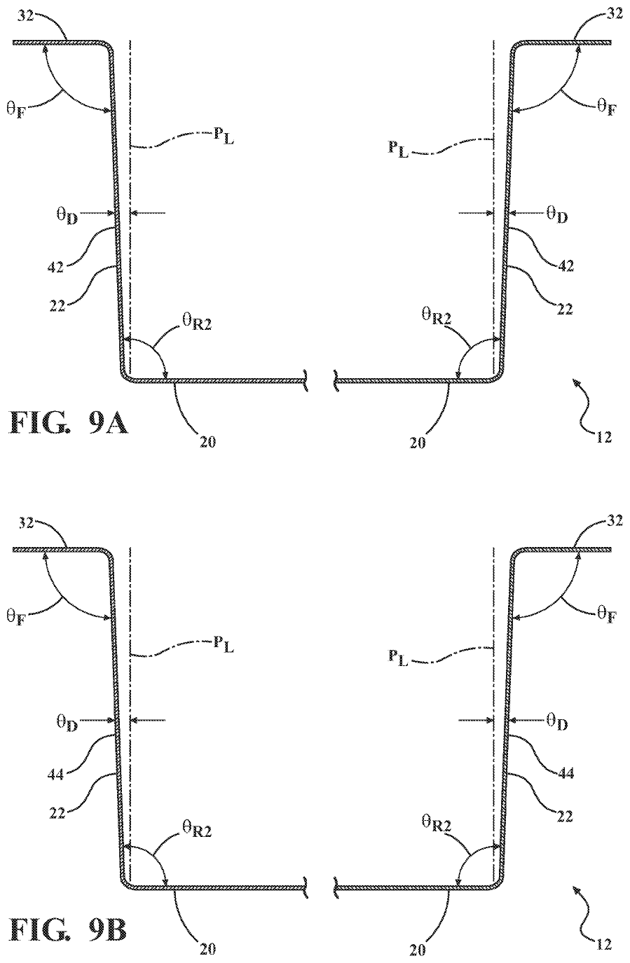

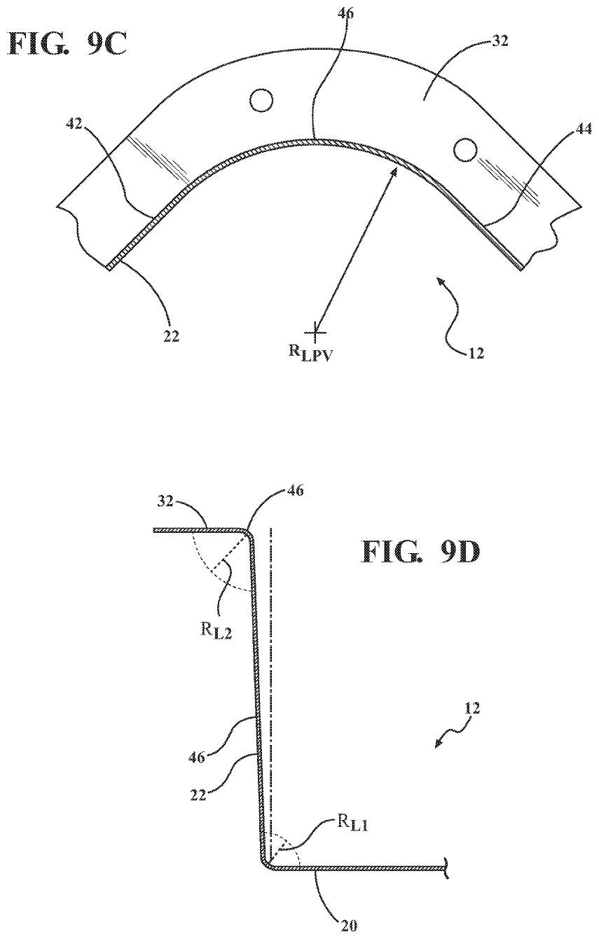

As shown in FIGS. 9A-9B, the resultant lower tub 12 formed as a one-piece stamped component from the two-part expansion forming process also advantageously has the same tight draft angle ⊖_{D} of less than two degrees, and more preferably of less than 1.5 degrees, as defined between the lower peripheral wall 22 and a lower plane P_{L} extending transversely to the base surface 20. Thus, similarly the angle ⊖_{R2} shown in FIGS. 9A-9B for the lower tub 12 (which is again the same as ⊖_{R2} for the OP-20 part shown in FIG. 3) is between 90 and 92 degrees, as defined between the base surface 20 (which would be the upper surface 17 in FIG. 3) and the lower peripheral wall 22 (which would be the side surface 19 in FIG. 3).

The tight draft angles ⊖_{D} for the lower and upper peripheral walls 22, 28—which are close to zero (and thus result in an angle of close to 90 degrees for ⊖_{R2})—advantageously provides for more space in the internal cavity 16 relative to the prior art designs, which have larger draft angles that necessarily result in the peripheral walls of the prior art upper covers and lower tubs encroaching into the internal cavity 16. With reference to FIG. 3, the angle of ⊖_{R1} is preferably 1.5 to 2 degrees greater and more open than ⊖_{R2} in the two-part expansion forming process to achieve these tight draft angles ⊖_{D} for the lower and upper peripheral walls 22, 28.

As mentioned previously, the two-part expansion forming process can also achieve sharper corners in the resultant OP-20 one-piece stamped component than achievable in the prior art one-piece stamped components, namely because the corners are drawn or expanded radially outwardly in the second forming step (as shown in FIG. 5A). With reference to the exemplary battery housing 10, and as best illustrated in FIGS. 1-2, the upper peripheral wall 28 of the upper cover 14 is comprised of a pair of upper side walls 36 extending in spaced and generally parallel relationship with one another, a pair of upper end walls 38 extending in spaced and generally parallel relationship with one another and generally transverse relationship to the upper side walls 36, and at least one sharp upper corner 40 extending between one of the upper side walls 36 and one of the upper end walls 38. For example, the exemplary upper cover 14 illustrated in FIGS. 1-2 includes two sharp upper corners 40 extending between opposing ends of one of the upper end walls 38 and a respective one of the pair of upper side walls 36. However, the upper cover 14 could include more or less sharp upper corners 40, such as four sharp upper corners 40 each extending between one of the upper side walls 36 and one of the upper end walls 38, without departing from the scope of the subject disclosure.

Similarly, the lower peripheral wall 22 of the lower tub 12 is comprised of a pair of lower side walls 42 extending in spaced and generally parallel relationship with one another, a pair of lower end walls 44 extending in spaced and generally parallel relationship with one another and generally transverse relationship to the lower side walls 42, and at least one sharp lower corner 46 extending between one of the lower side walls 42 and one of the lower end walls 44. For example, the exemplary lower tub 12 illustrated in FIGS. 1-2 includes two sharp lower corners 46 extending between opposing ends of one of the lower end walls 44 and a respective one of the pair of lower side walls 42, to match a profile of the upper cover 14. However, the lower tub 12 could include more or less sharp lower corners 46, such as four sharp lower corners 46 each extending between one of the lower side walls 42 and one of the lower end walls 44, without departing from the scope of the subject disclosure.

As best illustrated in FIGS. 7A and 8C, each sharp upper corner 40 extends arcuately between the respective upper side wall 36 and the respective upper end wall 38 along a plan view upper corner radius R_{UPV} in the range of between 20-95 mm. Put another way, each sharp upper corner 40 when viewed from a plan view perspective and in cross-section is arcuately shaped with a plan view upper corner radius R_{UPV} in the range of between 20-95 mm. Similarly, as best illustrated in FIGS. 7B and 9C, each sharp lower corner 46 extends arcuately between the respective lower side wall 42 and the respective lower end wall 44 along a plan view lower corner radius R_{LPV} in the range of between 20-95 mm. Again, putting this another way, each sharp upper corner 46 when viewed from a plan view perspective and in cross-section is arcuately shaped with a plan view lower corner radius R_{LPV} in the range of between 20-95 mm. The plan view corner radii for the sharp upper and lower corners 40, 46 are advantageously smaller (and thus tighter) than achievable in the prior art one-piece stamped components, without encountering quality and manufacturing defects such as springback, metal splitting and strain for the upper and lower peripheral walls 22, 28.

The sharp upper and lower corners 40, 46 also have smaller radii relative to the prior art corners as they transition into the adjacent top/base surfaces 20, 26 and the adjacent upper/lower flanges 32, 34. More specifically, as best illustrated in FIGS. 7A and 8D, each sharp upper corner 40 includes a first upper corner radiused portion 48′ disposed adjacent the top surface 26 and which is curved to transition concavely from the sharp upper corner 40 to the top surface 20 with a first upper radius R_{U1} in the range of between 4-19 mm, and a second upper corner radiused portion 50′ disposed adjacent the upper flange 34 and which is curved to transition convexly from the sharp upper corner 40 to the upper flange 32 with a second upper radius R_{U2} in the range of between 4-7 mm. Similarly, each sharp lower corner 46 includes a first lower corner radiused portion 48″ disposed adjacent the base surface 20 and which is curved to transition concavely from the sharp lower corner 46 to the base surface 20 with a first lower radius R_{L1} in the range of between 4-19 mm, and a second lower corner radiused portion 50″ disposed adjacent the lower flange 32 and which is curved to transition convexly from the sharp lower corner 46 to the lower flange 34 with a second lower radius R_{L2} in the range of between 4-7 mm. Applicant found that the following first and second radiused portions 48, 50 are most preferred to achieve the desired plan view radius for the respective sharp upper or lower corners 40, 46.

| | | | | |
|---|---|---|---|---|
| Plan View Radius | 20 mm | 45 mm | 70 mm | 95 mm |
| First Radiused Portion | 19 mm | 14 mm | 9 mm | 4 mm |
| Second Radiused Portion | 7 mm | 6 mm | 5 mm | 4 mm |

And in further relation to the tight draft angles ⊖_{D} formed in the lower tub 12 and the upper cover 14, the tight draft angles ⊖_{D} extend around the perimeter of the lower and upper peripheral walls 22, 28 such that, as best shown in FIGS. 8A and 9A, a combined tight draft angle as collectively defined by opposing upper/lower side walls 36, 42 of the upper/lower peripheral walls 22, 28 is four degrees or less (i.e., two degrees or less for each lower or upper side wall 36, 42 in the opposing pair of upper/lower side walls 36, 42). Similarly, as best shown in FIGS. 8B and 9B, a combined tight draft angle as collectively defined by opposing upper/lower end walls 38, 44 is also four degrees or less (i.e. two degrees or less for each lower or upper end wall 38, 44 in the pair of opposing pair of upper/lower end walls 38, 44).

As best illustrated in FIGS. 1-2, a preferred draw depth for the upper cover 14 and thus resultant upper wall height H_{U} for the upper peripheral wall 28 is equal to or greater than 100 mm, as defined by and extending between the top surface 26 and the upper flange 34. Similarly, a preferred draw depth for the lower tub 12 and thus resultant lower wall height H_{L} for the lower peripheral wall 22 is equal to or greater than 100 mm, as defined by and extending between the base surface 20 and the lower flange 32. Further, as shown in FIGS. 8A-B and 9A-B, a preferred flange angle ⊖_{F} between the lower or upper flange 32, 34 and the respective lower or upper peripheral walls 22, 28 is between 80 to 110 degrees.

As noted previously, the lower tub 12 and upper cover 14 formed from the two-part expansion process are preferably comprised of steel having mechanical properties of greater than 110 MPa yield strength, and most preferably of a yield strength between either 110-140 MPa, 180-300 MPa, or 340-550 MPa.

It has been unexpectedly found that a lower tub 12 and upper cover 14 formed from the two-part expansion process yields a part with significantly less thinning and plastic strain of the lower and upper peripheral walls 22, 28 as compared to parts formed using the conventional methods described in the background section. More specifically, conventional processes result in ~14% thinning and ~18% plastic strain on a prior art peripheral wall of the lower tub or upper cover, where the two-part expansion process shows ~0% thinning and ~0% plastic strain on the lower and upper peripheral walls 22, 28 for the resultant OP-20 part (in this case the lower tub 12 and/or the upper cover 14). Accordingly, the lower tub 12 and upper cover 14 formed from the two-part expansion process not only results in one-piece stamped components with tighter draft angles and sharper corners, but also one-piece stamped components having higher quality and improved integrity (~0% thinning and ~0% plastic strain on the lower and upper peripheral walls 22, 28) relative to the prior art one-piece stamped components.

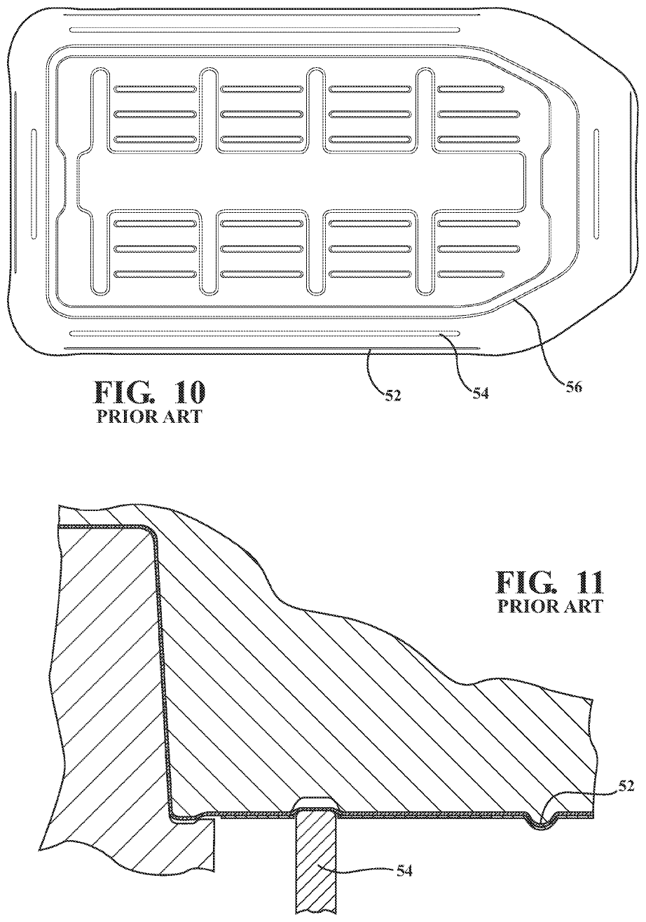

More specifically in relation to the method of manufacturing, as best shown in FIGS. 10-11, conventional manufacturing processes for forming one-piece stamped components also require the use of drawbeads 52 and staker beads 54 to add strain and thinning to the peripheral wall to counter act wall curl, which necessarily requires that these features be removed from the formed part, such as along the illustrated prior art “Product Trim Line” 56. Put another way, since the drawbead 52 leaves a mark that cannot end up on the seal surface or product, the drawbead must be placed far from the “Product Trim Line” 56. However, as shown in FIG. 9, this results in significant material waste in the conventional manufacturing process.

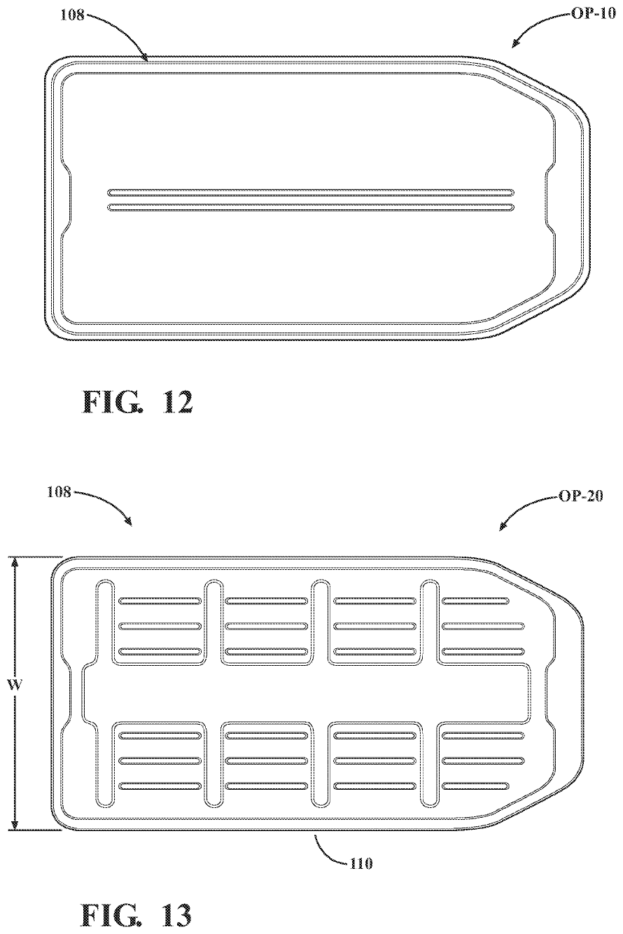

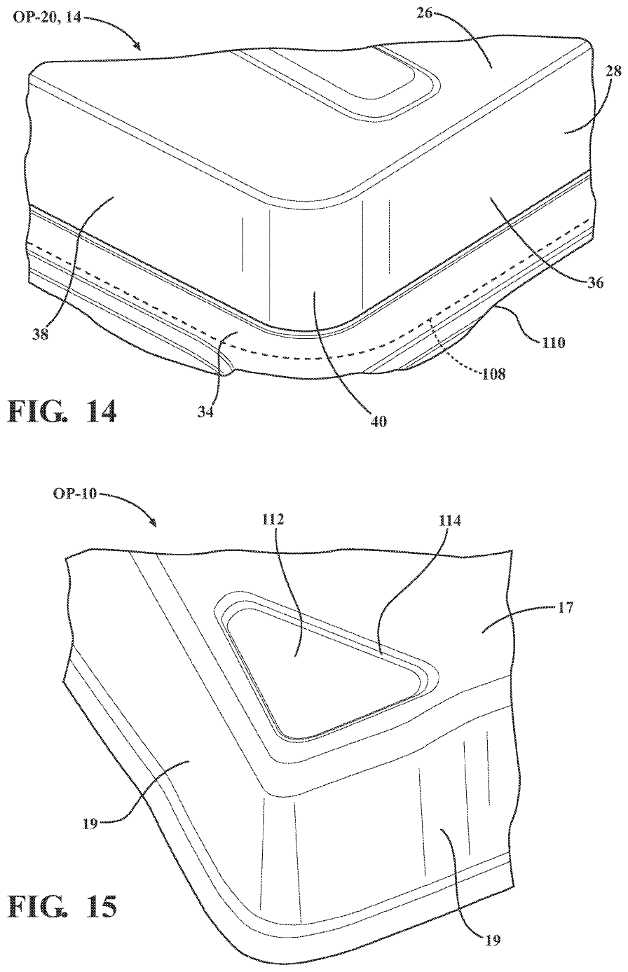

As best shown in FIG. 12-14, the subject two-part expansion forming process advantageously eliminates use of the drawbeads through inclusion of a lock step feature 106 in the second stamping press 104 (See FIG. 5A), which counter acts the curl by ironing the steel material in OP-10 from the inside of the second stamping press 104 to counter-balance the curling tendency. Put another way, as shown in FIG. 5A, the second stamping press 104 includes a lock step feature 106 defined between the second upper die 126 and the binder 116 for forming the final part OP-20, which holds an outer edge of the OP-10 in place, and prevents retraction further into the second stamping press 104 during the second forming operation step. The lock step feature 106 also results in a formed OP-20 part having significantly less material waste (up to 25% material savings)—namely because the subject “Product Trim Line” 108 is closer to an outer edge 110 of the formed OP-20 part, and less material must be trimmed and discarded in a final trimming step relative to prior art methods. (See a comparison of the prior art Product Trim Line 56 in FIG. 10 (“Prior Art”) versus the subject “Product Trim Line” 108 in FIG. 13). Put another way, since the drawbead is not present, there is no risk of marking the panel and damaging the seal surface, and the subject “Product Trim Line” 108 can be placed significantly closer to the outer edge 110 of the formed OP-20 part. This provides an attendant material advantage and related costs savings for the subject two-part expansion forming process, as a result of the final trimming step.

Since the drawbead is removed, and the subject “Product Trim Line” 108 is closer to an outer edge 110 of the formed OP-20 part, the two-part expansion forming process can also achieve a wider formed part from a single unitary blank than achievable from the prior art methods. For example, as best illustrated in FIG. 13, a final OP-20 part having a width W of up to 1571 mm can be achieved from a 72″ maximum coil width.

Conventional processes for forming the battery housing also exhibit ~6% thinning along the portion of the peripheral walls which define the corner portions. However, in contradistinction, the two-part expansion forming process can achieve ~3.5% thickening of the upper and lower peripheral walls 22, 28 disposed adjacent each of the sharp upper and lower corners 40, 46. As illustrated in FIGS. 4B and 15, the first step of the expansion forming process includes forming a metal gainer feature 112 in the upper surface 17 of the OP-10 part (which as explained above ultimately corresponds to the base surface 20 or the top surface 26 of the respective lower tub 12 or upper cover 14) adjacent a portion of the side surface 19 intended to form the sharp upper and lower corner(s) 40, 46 in the resultant OP-20 part (e.g., the lower tub 12 or the upper cover 14). For clarity, FIG. 4B illustrates a top view of the portion of OP-10 formed from the fragmentary cross-sectional view of the first stamping press 102 shown in FIG. 4A. The metal gainer feature 112 extends away from (e.g., downwardly or upwardly from) the upper surface 17 of the OP-10 part to provide a perimeter of extra metal material 114 that can be utilized in the subsequent OP-20 forming step (shown in FIG. 5A).

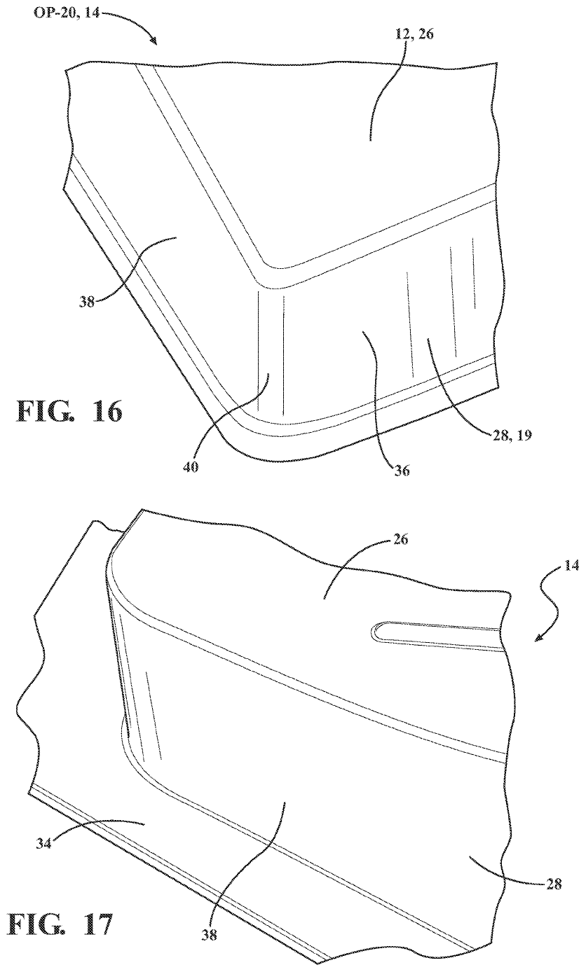

As best illustrated in FIGS. 5B and 16, in the second step of the expansion forming process, the metal gainer feature 112 is flattened or smoothed out, such that the perimeter of extra metal material 114 can be utilized when forming OP-20 and the tight draft angles without compromising formation of the sharp upper or lower corners 40, 46 through thinning. Once again, for clarity, FIG. 5B illustrates a top view of the portion of OP-20 formed from the fragmentary cross-sectional view of the second stamping press 104 shown in FIG. 5A. The thickening of the sharp upper or lower corners 40, 46 can be achieved in the forming of the first part OP-10, and maintained or alternatively thickened in the forming of the second part OP-20 by way of the metal gainer feature 112. Although illustrated as being disposed adjacent a portion of the side surfaces 19 intended for use in forming the sharp upper or lower corners 40, 46, the metal gainer feature 112 could also be disposed along other portions of the upper surface 17 without departing from the scope of the subject disclosure, to facilitate thickening of related portions of the battery housing 10.

In summary, the method of manufacturing the lower tub 12 or the upper cover 14 via the two-part expansion forming process begins by placing the metal blank 100 comprised of steel having a yield strength of greater than 110 MPa within a first stamping press 102 comprised of a binder 116, a first upper die 118 and a first lower punch 120. (See FIG. 4A). The metal blank 100 is compressed between the first upper die 118 and the first lower punch 120 in the first forming operation step to initially form the first part OP-10 having the upper surface 17 arranged relative to the side surface 19 at the first larger angle ⊖_{R1}. (See FIG. 3). As illustrated in FIG. 4A, the first upper die 118 preferably includes at least one metal gainer protrusion 122 and the first lower punch 120 includes at least one metal gainer depression 124 aligned with and correspondingly shaped to the at least one metal gainer protrusion 122 to form the at least one metal gainer feature 112 in the upper surface 17 of the first part OP-10, adjacent a portion of the side surface 19 intended to form the at least one sharp upper or lower corner 40, 46. (See FIG. 4B). As discussed previously, the forming of the at least one metal gainer feature 112 provides a perimeter of extra metal material 114 that can be utilized in the subsequent OP-20 forming operation step.

The method of manufacturing proceeds in FIG. 5A by placing the first part OP-10 within the second stamping press 104 comprised of a second upper die 126 and a second lower punch 128, and compressing the first part OP-10 between these components in the second forming operation step to expand the first part OP-10 to its final form in OP-20 (See FIG. 5B) and establish the reduced second smaller angle ⊖_{R2} of 90 to 92 degrees (and thus the tight draft angle of less than 2 degrees) between the upper surface 17 and the side surface 19 (See FIG. 3). As illustrated in FIG. 5A, the second upper die 126 includes an upper lock step 130 and the binder 116 includes a lower lock step 132 which is aligned with and correspondingly shaped to the upper lock step 130 to collectively establish the lock step feature 106 which engages or clamps with an edge of the first part OP-10 during the second forming operation step. The lock step feature 106 holds an edge of the first part OP-10 in place, and prevents the edge of the first part OP-10 from retracting further into the second stamping press 104. Thus, as shown in FIGS. 5B and 16, the at least one metal gainer feature 112 previously formed in the first part OP-10 is flattened or smoothed out (as a result of a pulling force, at least partially by the stationary edge of the first part OP-10, as established by the lock step feature 106), such that the perimeter of extra metal material 114 is drawn out in the second forming operation step and utilized to form the tight draft angles of the final part OP-20 without compromising formation of the at least one sharp upper or lower corner 40, 46 through thinning. Notably, as illustrated in FIG. 5A, the second upper die 126 and second lower punch 128 include flat or planar forming surfaces on opposite sides of and adjacent the location of the at least one metal gainer feature 112 to assist in the flattening or smoothing out of the at least one metal gainer feature 112 in the formed OP-20 final part.

The method of manufacturing concludes by trimming the formed OP-20 final part along the “Product Trim Line” 108 extending near and next adjacent to the outer edge 110, to remove the lock step feature 106 and complete formation of the OP-20 final part, in this case either the lower tub 12 or the upper cover 14.

In more detail relative to other features of the resultant lower tub 12 or upper cover 14, although not expressly shown, a seal can be disposed between the upper flange 34 and the lower flange 32 and preferably extends around the entire perimeter of the battery housing 10 to establish a sealed relationship between the upper cover 14 and the lower tub 12 when these components are interconnected to one another for preventing the passing of contaminants from the environment and into the internal cavity 16 of the battery housing 10. As further illustrated in FIG. 2, in a preferred arrangement, the lower flange 32 defines a plurality of lower apertures 58 disposed in spaced relationship with one another, and the upper flange 34 defines a plurality of upper apertures 60 disposed in spaced relationship with one another and each disposed in aligned relationship with a respective one of the plurality of lower apertures 58. A plurality of flange fasteners (not shown), such as a paired bolt and nut, are each passed through and secured to a respective pair of the aligned lower and upper apertures 58, 60 to secure the upper cover 14 and the lower tub 12 to one another and enclose the plurality of battery modules 18 within the internal cavity 16. However, the lower flange 32 and the upper flange 34 could alternatively be connected to one another via other means, such as via welding, without departing from the scope of the subject disclosure.

A plurality of cross members 64 are disposed inside the internal cavity 16 and extend transversely between opposing sides of the lower sidewall 22 of the lower tub 12 and the upper sidewall 28 of the upper cover 14 to provide support for the battery housing 10 for crash performance. As best illustrated in FIG. 2, the cross members 64 are preferably disposed between adjacent rows of the plurality of battery modules 18 to also provide support for and absorb side-to-side movement of the battery modules 18 during operation of the battery housing 10. Each of the plurality of battery modules 18 are preferably secured to adjacent ones of the plurality of cross members 64 to maintain a position of the battery modules 18 within the internal cavity 16.

As further illustrated in FIG. 2, at least one cooling plate 74 is preferably disposed within the internal cavity 16 and extends underneath and preferably in contact with the plurality of battery modules 16 for cooling the battery modules 16 during operation. Although not expressly illustrated, the cooling plate 74 can be connected to a coolant system of the automobile to introduce coolant to the at least one cooling plate 54. A lower tub reinforcement 78 extends within the internal cavity 16, and is disposed between the cooling plate 74 and the base surface 20 of the lower tub 12, to protect the at least one cooling plate 74 and the plurality of battery modules 16 from a lower impact. However, the lower tub reinforcement 78 could be disposed outside of the battery housing 10 and extend along an exterior surface of the lower tub 12 without departing from the scope of the subject disclosure. In a preferred arrangement, the lower tub reinforcement 78 is comprised of a reinforcement plate 80 which extends along the base surface 20 of the lower tub 12 and includes a plurality of support members 82 extending upwardly in spaced relationship with one another, each having an inverted U-shaped cross-section.

As further illustrated in FIG. 2, the exemplary battery housing 10 includes a frame 86 disposed in surrounding relationship with the lower sidewall 22 of the lower tub 12 and extending underneath a portion of the base surface 20 to provide additional structural integrity and protection to the battery housing 10. In a preferred arrangement, the frame 86 is also formed from stamping metal, such as steel or aluminum, to provide a one-piece integral component, and includes a frame flange 88 which extends and is arranged underneath the lower flange 32. The frame flange 88 defines a plurality of lip apertures 90 disposed in spaced relationship with one another and each disposed in aligned relationship with a respective pair of the aligned lower and upper apertures 58, 60. Accordingly, the plurality of flange fasteners (not expressly shown) additionally pass through respective ones of the plurality of flange apertures 90 to secure the frame 86 to the lower tub 12 and the upper cover 14. As best illustrated in FIG. 1, the battery housing 10 can include a plurality of body mounts 92 disposed along and outwardly of the upper sidewall 28 of the upper cover 14 for use in mounting the battery housing 10 to a portion of the vehicle.

Obviously, many modifications and variations of the present disclosure are possible in light of the above teachings and may be practiced otherwise than as specifically described. For example, although the two-part expansion process has been described and illustrated in relation to forming an upper cover and a lower tub for a battery housing, as mentioned previously the two-part expansion process can also be applied to forming other parts, including other vehicle parts, without departing from the scope of the subject disclosure.

1. A battery housing comprising:
a lower tub including a base surface and a lower peripheral wall extending upwardly from a peripheral lower edge of the base surface;
an upper cover including a top surface and an upper peripheral wall extending downwardly from a peripheral upper edge of the top surface;
the upper cover disposed on said lower tub to collectively define an internal cavity;
at least one battery module disposed in said internal cavity and enclosed between said lower tub and said upper cover; and
at least one of said lower tub or said upper cover being formed as a one-piece stamped component and having a tight draft angle of less than two degrees as defined between said respective upper or lower peripheral wall and a plane extending transversely to said respective top or bottom surface.

2. The battery housing as set forth in claim 1, wherein each of said lower tub and said upper cover are formed as one-piece stamped components each having the tight draft angle of less than two degrees between both said upper peripheral wall and an upper plane extending transversely to said top surface of said upper cover and between said lower peripheral wall and a lower plane extending transversely to said base surface of said lower tub.

3. The battery housing as set forth in claim 2, wherein both of said lower tub and said upper cover are comprised of steel having a yield strength of greater than 110 MPa.

4. The battery housing as set forth in claim 2, further comprising:
said lower tub including a lower flange extending outwardly from said lower peripheral wall;
said upper cover including an upper flange extending outwardly from said upper cover;
said upper peripheral wall having an upper wall height extending between said top surface and said lower flange being equal to or greater than 100 mm; and
said lower peripheral wall having a lower wall height extending between said base surface and said lower flange being equal to or greater than 100 mm.

5. The battery housing as set forth in claim 4, wherein said upper peripheral wall includes a pair of upper side walls, a pair of upper end walls, and at least one sharp upper corner extending arcuately between one of said upper side walls and one of said upper end walls along a plan view upper corner radius in the range of between 20-95 mm.

6. The battery housing as set forth in claim 5, wherein said at least one sharp upper corner having a first upper corner radiused portion disposed adjacent said top surface and being curved to transition from said at least one sharp upper corner to said top surface with a radius in the range of between 4-19 mm.

7. The battery housing as set forth in claim 5, wherein said at least one sharp upper corner having a second upper corner radiused portion disposed adjacent said upper flange and being curved to transition from said at least one sharp upper corner to said upper flange with a radius in the range of between 4-7 mm.

8. The battery housing as set forth in claim 5, wherein the tight draft angle defined by each of said pair of upper side walls relative to said top surface is collectively less than four degrees.

9. The battery housing as set forth in claim 8, wherein the tight draft angle defined by each of said pair of upper end walls relative to said top surface is collectively less than four degrees.

10. The battery housing as set forth in claim 4, wherein said lower peripheral wall includes a pair of lower side walls, a pair of lower end walls, and at least one sharp lower corner extending arcuately between one of said lower side walls and one of said lower end walls along a plan view lower corner radius in the range of between 20-95 mm.

11. The battery housing as set forth in claim 10, wherein said at least one sharp lower corner having a first lower corner radiused portion disposed adjacent said base surface and being curved to transition from said at least one sharp lower corner to said base surface with a radius in the range of between 4-19 mm.

12. The battery housing as set forth in claim 10, wherein said at least one sharp lower corner having a second lower corner radiused portion disposed adjacent said lower flange and being curved to transition from said at least one sharp lower corner to said lower flange with a radius in the range of between 4-7 mm.

13. The battery housing as set forth in claim 10, wherein the tight draft angle defined by each of said pair of lower side walls relative to said base surface is collectively less than four degrees.

14. The battery housing as set forth in claim 13, wherein the tight draft angle defined by each of said pair of lower end walls relative to said base surface is collectively less than four degrees.

15. The battery housing as set forth in claim 4, wherein an upper flange angle between said upper flange and said upper peripheral wall and a lower flange angle between said lower flange and said lower peripheral wall are each between 80 to 110 degrees.

16. The battery housing as set forth in claim 1, wherein said at least one of said lower tub or upper cover that is formed as a one-piece stamped component has a yield strength of greater than 110 MPa.

17. The battery housing as set forth in claim 16, further comprising:
a flange extending outwardly from said at least one of said lower tub or upper cover; and
said upper or lower peripheral wall of said at least one of said lower tub or upper cover having a wall height extending between said flange and a respective one of said top or base surface, said wall height being equal to or greater than 100 mm.

18. The battery housing as set forth in claim 17, wherein said upper or lower peripheral wall includes a pair of side walls, a pair of end walls, and at least one sharp corner extending arcuately between one of said side walls and one of said end walls along a plan view corner radius in the range of 20-95 mm.

19. The battery housing as set forth in claim 18, wherein said at least one sharp corner having a first corner radiused portion disposed adjacent said respective top or bottom surface and being curved from said at least one sharp corner to said respective top or bottom surface with a radius in the range of between 4-19 mm.

20. The battery housing as set forth in claim 19, wherein said at least one sharp corner having a second corner radiused portion disposed adjacent said flange and being curved to transition from said at least one upper corner to said flange with a radius in the range of between 4-7 mm.
